(19) United States
(12) Patent Application Publication
(10) Pub. No.: US 2010/0198470 A1
(43) Pub. Date: Aug. 5, 2010

(54) Method and Device for Determining the Clutch Engagement Point in a Motor Vehicle

(75) Inventors: Thomas Reinhold Weck, Hadamar (DE); Lucian Lippok, Koln (DE)

Correspondence Address: Kristy J. Downing, Esq., 39555 Orchard Hill Pl., 6th Fl., PMB No.: 6051, Novl, MI, 48375, US

(73) Assignee: Ford Global Technologies LLC

(21) Appl. No.: 12/698,142

(22) Filed: Feb. 2, 2010

(30) Foreign Application Priority Data
Feb. 2, 2009 (DE) 10 2009 000 532.3

(51) Int. Cl. G06F 19/00

(52) U.S. Cl. 701/67

(57) ABSTRACT

The present disclosure relates to methods and devices for determining a clutch engagement point in a motor vehicle.

### CROSS-REFERENCE TO RELATED APPLICATIONS

This application is a continuing application and claims priority to German Patent Application No. 10 2009 000 532.3 titled “Method and Device for Determining the Clutch Engagement Point in a Motor Vehicle” filed Feb. 2, 2009, which is hereby incorporated by reference in its entirety.

### TECHNICAL FIELD

The present disclosure relates to a method (and a device) for determining the clutch engagement point in a motor vehicle.

### BACKGROUND

In vehicles which are equipped with a hill start assistance system (also referred to as Hill-Launch-Assist system or “HLA”), the driver is able to take their foot off the brake pedal and subsequently activate the accelerator pedal without the vehicle rolling backwards. The HLA system maintains the hydraulic brake pressure and holds the motor vehicle in the stationary state until the clutch engagement point is confirmed, after which the brake pressure is released.

The determination of the clutch engagement point is of particular significance for the HLA system since the engine torque is transmitted to the wheels and the vehicle can start only when the clutch is engaged. If the clutch engagement point is not determined carefully and precisely this results either in the vehicle rolling backward—since the brake pressure is released without the engine torque being transmitted to the wheels—or the engine stalls since the brake pressure is applied when the clutch is still engaged as the engine speed is reduced to zero.

The clutch engagement point is usually confirmed by using an analog sensor which senses the position of the clutch or of the clutch pedal. The clutch engagement can either be measured by means of the analog sensor (and stored) or the sensor signal can be used as an input signal for a further sensing logic which measures the clutch engagement point during the operation and stores the clutch engagement position at each clutch engagement for use with the next event. However, an analog sensor for determining the clutch engagement position increases the structural complexity and raises costs of the HLA system.

Furthermore, approaches to the solution of the above problem using software to sense the clutch engagement point have also proven inadequate. In the past sensing of the clutch engagement point is based on confirmation of a drop in the engine speed or inertia effects are utilized. These systems are inadequate since either an excessively late release or an undesired release can occur with these approaches.

For example, Great Britain Patent No: GB 2 376 997 A discloses a device for monitoring the clutch engagement point, in which the torque which is generated by the internal combustion engine and the rotational acceleration are measured and/or estimated. In this context the clutch engagement point is monitored by sensing a significant drop in the proportionality between a measured engine torque and a measured rotational acceleration.

Another reference, European Patent Application No. EP 1 327 566 B1, discloses a starting aid control device which has one or more sensing devices for sensing signals and an evaluation unit for forming a starting desired signal. The evaluation unit evaluates, for example, the signal of an incline angle sensor to determine whether a predefined threshold value is exceeded in order to detect a starting jolt.

Therefore, it is desirable to make available a method and a device for determining the clutch engagement point in a motor vehicle which permits reliable determination of the clutch engagement point together with a comparatively small structural design.

### SUMMARY

The present invention may address one or more of the above-mentioned issues. Other features and/or advantages may become apparent from the description which follows.

Certain embodiments of the present invention include a method for determining the clutch engagement point in a motor vehicle which can be driven by means of an engine has the following steps: determining a plurality of input signals characteristic of an operating state of the engine; and evaluating the plurality of input signals in a plurality of criteria which are independent of one another in order to determine the clutch engagement point. At least one of the plurality of criteria is deactivated at least temporarily as a function of the state of the engine.

Another embodiment of the present invention includes a method for determining the clutch engagement point in a motor vehicle, comprising: performing a criterion system check related to clutch engagement inertia, static torque, clutch engagement torque, time controls or rapid clutch engagements; transmitting at least one input signal related to the criterion system check to a control module; determining a clutch engagement point based on the input signal; and releasing a brake pressure according to the criterion system check.

Various engine-specific signals or criteria are used to determine the clutch engagement point. In particular, the engine speed and the rate of change of the engine speed, the throttle valve opening and the rate of change of the throttle valve position as well as the calculated engine torque are used as input signals. These signals are transmitted from the drive train control module to the brake control module via a CAN (Controlled Area Network) bus; therefore, the system does not increase the structural complexity or raise the hardware costs.

It is conceivable that none of the criteria are suitable individually for precisely determining the clutch engagement point since the quality (or informative power) and use of the respective input signals is limited as a function of the current operating state. For this reason, specific operating windows within which the criterion for determining the clutch engagement point is used are preferably employed for each criterion. These operating windows can depend upon both the operating range of the input signal and on the point in time during the engagement. All the criteria can be used in parallel or simultaneously. If the clutch engagement point is determined by one of these criteria, the hydraulic brake pressure is released according to the HLA system.

Even though certain embodiments of the present invention are suitable in particular for use in motor vehicles with a hill start assistance system, the invention is not restricted thereto. Further advantageous embodiments of the present invention are, for example, hydraulic brake control systems or electrically activated parking brakes (often referred to as “Electric Parking Brake” or “EPB”). The present invention can also permit the use of an analog sensor for determining the clutch engagement position to be avoided in conjunction with such systems.

The brake pressure is released by means of the HLA system if one of the release criteria triggers or initiates the release. The most precise triggering or initiation possible by means of the release signals is related to being able to achieve gentle starting of the vehicle. If the triggering takes place too early the vehicle may roll back downhill (i.e., in a direction opposite the desired direction of travel). If the triggering occurs too late the brake is still active during the engagement of the clutch which can result in the engine being stalled.

According to one embodiment, the following release criteria can be used: a) inertia criterion—sensing of changes in the moment of inertia which are caused by the clutch engagement (a relationship between the engine torque and engine speed); b) static torque criterion—confirmation of states in which the engine torque and the rotational speed are stable, while the engine speed is sufficiently high to hold the vehicle; c) torque criterion—sensing of a drop in the engine torque which is caused by the clutch engagement, while the engine torque is sufficiently high to hold the vehicle; d) time control criterion—sensing of states in which the engine torque remains constant while the clutch slowly approaches the clutch engagement point; and e) engine stalling criterion—sensing of rapid clutch engagements which can lead to the engine stalling.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

The invention will be explained in more detail below by means of a preferred exemplary embodiment and with reference to the appended figures, of which:

FIG. 1 shows a time profile during system determination of a clutch engagement point according to one embodiment of the present invention;

FIG. 2 shows a flowchart of the parallel use of different criteria for a determination of a clutch engagement point; and

FIGS. 3-7 show flowcharts of the applications of individual criteria in the overview flowchart of FIG. 2.

### DETAILED DESCRIPTION

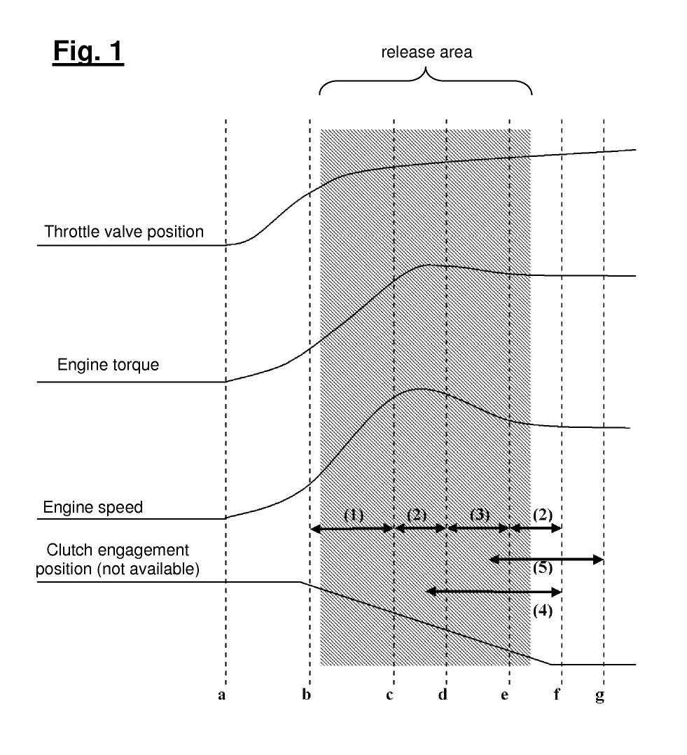

FIG. 1 shows a flowchart explaining a typical time profile during the determination of a clutch engagement point. The clutch engagement state is sensed with sensor support on the basis of the engine speed, the engine torque, the position of the accelerator pedal and on the basis of the changes in these signals over time. Release criteria use these data input signals during different phases of the clutch engagement in various ways. An exemplary time profile is illustrated in FIG. 1. FIG. 1 also shows which criteria are active for the initiation of a release of the brake.

The clutch engagement position itself is unknown (or “not available” as shown in FIG. 1) in this embodiment since a continuous clutch engagement position signal is not available. The clutch engagement can occur a certain time period after the release of the clutch pedal (indicated as the hatched area labeled “release area” on FIG. 1). During this time period, the engine torque has reached a specific torque level due to the activation of the accelerator pedal and the torque level must be high enough for the vehicle to be able to start without the engine stalling. The hill start assistance should occur gently and the driver should not perceive the release of the brake.

The individual successive phases in the time profile according to FIG. 1 will are explained herein below.

Before the time “a”, the motor vehicle was stopped. The HLA system is active and the brake pressure has been fixed.

In the phase labeled “a-b” (i.e., between the times “a” and “b”), the driver starts the process of hill start assistance by depressing the accelerator pedal while releasing the clutch pedal.

In the phase labeled “b-c”, an inertia criterion (1) can be calculated on the basis of the engine torque and the rate of change of the engine speed. This criterion permits an early release and contributes to a more gentle assistance of the starting process. In this embodiment, the inertia criteria can only be applied in this phase. Furthermore, pronounced changes in the engine speed have to be sensed in order to avoid a release occurring incorrectly.

In the phase labeled “c-d”, a stabilizing engine torque and an engine speed level are confirmed by means of the static torque criterion (2). It also checks whether the torque is sufficiently high to accelerate the vehicle.

In the phase labeled “d-e”, a drop in the engine speed due to the clutch engagement is sensed by means of the torque criterion (3). If the engine speed has already dropped, this criterion occurs somewhat late, which can be perceived by the driver.

In the phase labeled “e-f”, the states which can lead to the release on the basis of the static torque criterion (2) also occur very late during a clutch engagement.

In the phase labeled “d/e-g”, the engine stalling criterion (5) can sense states in which the engine can be stalled and avoids such states by releasing the brake pressure. If the engine speed drops quickly below the idling speed, a release occurs, but it is clearly perceived by the driver.

In the phase labeled “c/d-g”, the time control criterion (4) is very similar to the static torque criterion (2). Stabilizing torque states and rotational speed states are also confirmed. Slow engagement processes which cannot be confirmed in another way (constant throttle valve position and very slow clutch engagement) are also checked. These states have to be validated by means of a timer in order to avoid a release occurring incorrectly and they can be perceived by the driver.

The driver is generally not able to perceive the release of the brake. The early release criteria therefore contribute substantially to a soft starting process. Nevertheless, these criteria can be limited in order to avoid a release occurring incorrectly and they are deactivated under certain predetermined conditions.

The common application of all the release criteria described above ensures a release in all operating states.

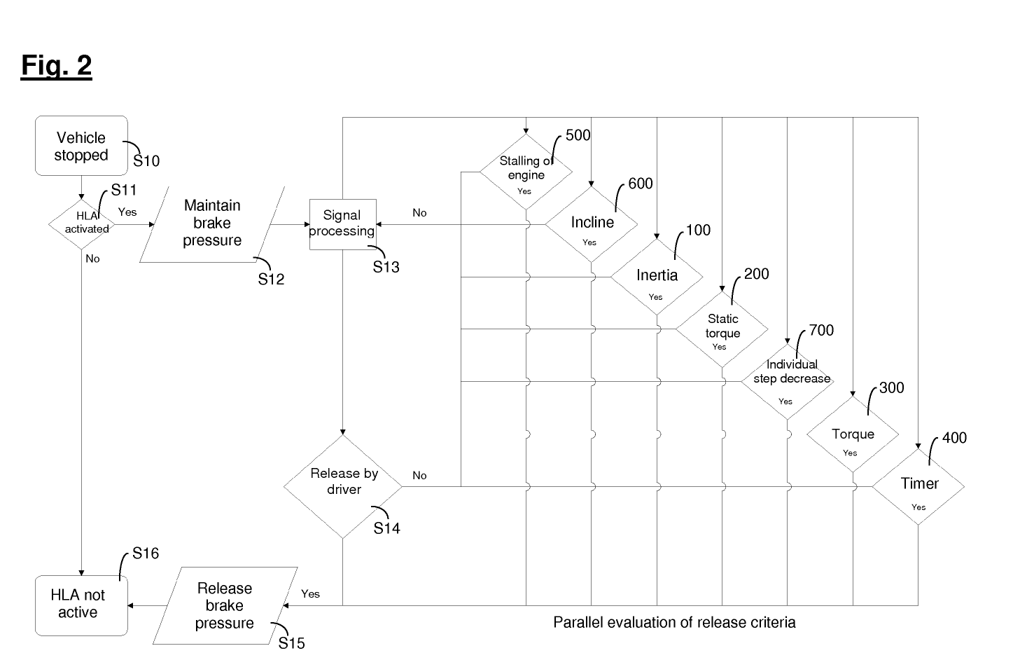

Referring now to FIG. 2, a method for determining a clutch engagement point in a motor vehicle which can be driven by means of an engine is shown. In step S10, the vehicle is stopped. In step S11, checking is performed to determine whether the HLA system is activated. If the system is inactive a transition occurs to step S16. If the HLA system is activate the brake pressure is maintained in step S12 and in step S13 signal processing occurs with parallel evaluation of the release criteria system checks 100-700. In step S14 checking is performed to determine whether a driver has brought about a release. If this is the case, in step S15 the brake pressure is released and a transition to step S16 occurs.

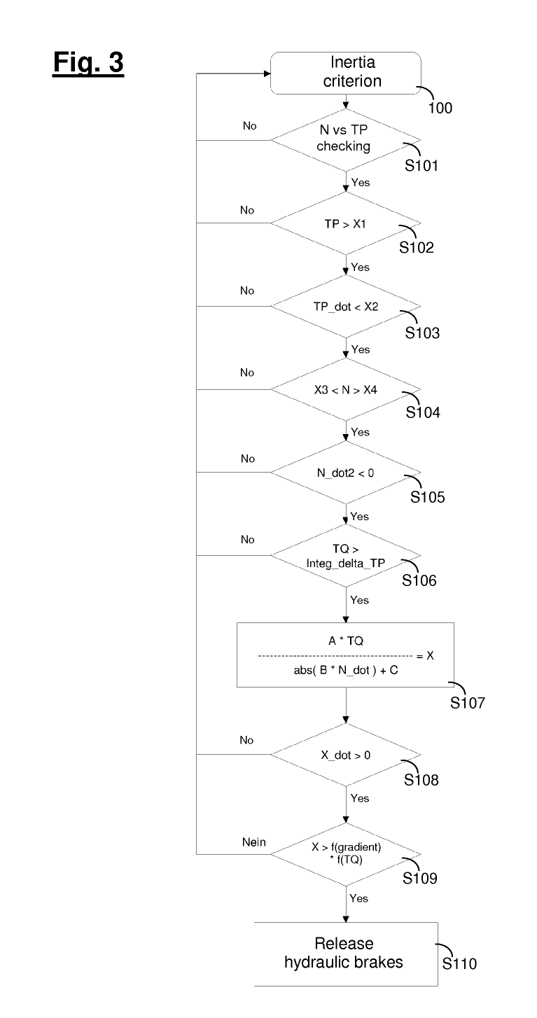

In the case of the inertia criterion system check 100, according to FIG. 3, a pre-selection with respect to changes in the engine speed which are due to an input relating to the throttle valve position or due to activation of the accelerator pedal is performed in step S101. In step S02, checking is carried out to determine whether the throttle valve opening is sufficiently large. Step S103 serves to check whether the change in the throttle valve position occurs sufficiently slowly (TP_dot denotes here the derivation of the throttle valve position over time). In step S104 the system checks whether the engine speed is between predefined limiting values. In step S105 the system checks whether the engine speed is still approaching a setting value. In step S106, the system checks whether the torque signal shows sufficient dynamics with respect to the throttle valve input. In step S107, a virtual inertia signal is calculated according to a specified formula. In step S108, the time delay between the engine speed and the calculated torque signal is taken into account. At step S109 the system takes into account different sensitivities as a function of the current state. In step S110, the hydraulic brake is released, accordingly, the driver is able to start the vehicle.

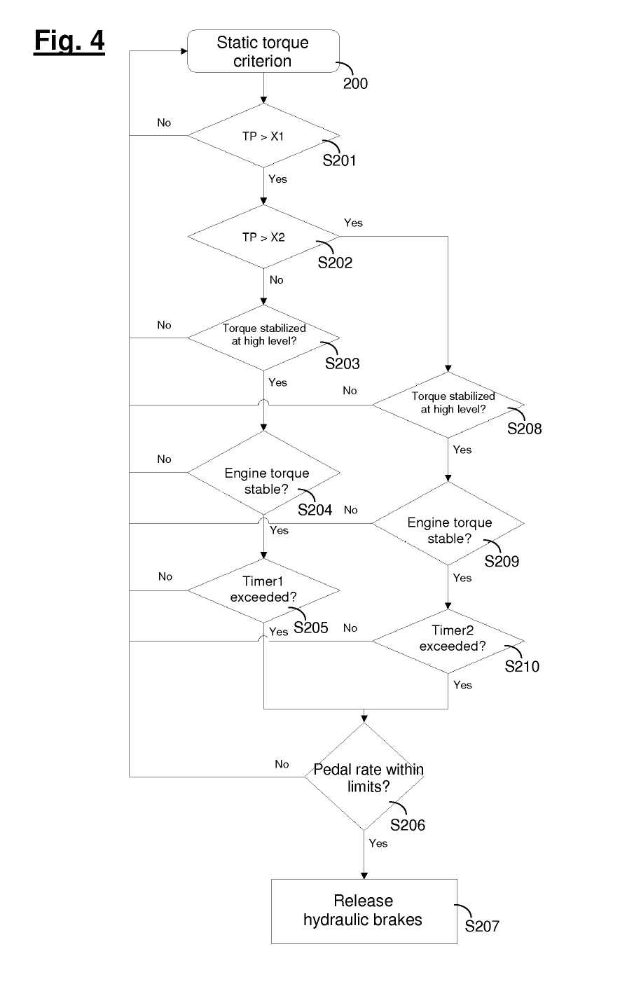

In the static torque criterion system check 200, according to FIG. 4, system checking is carried out in a first step S201 to determine whether the throttle valve opening or accelerator pedal position exceeds a first limiting value X1 (i.e., is sufficiently large). If this is the case, checking is carried out in step S202 to determine whether a second limiting value X2 is also exceeded (i.e., the throttle valve opening is even larger). Depending on whether the checking in step S202 yields “yes” or “no”, checking is carried out on different paths S203 and S208 to determine whether the torque is stable at a higher level. For this purpose, a counter-torque is applied with the position of the clutch pedal being modified. If the result of the answer at steps S203 or S208 is “yes”, in step S204 and in step S209 checking is carried out to determine whether the engine speed remains stable and does not exceed predetermined limits. If this is the case, in step S205 or step S210 the system checks to determine whether a time period Time1 or Timer2 has been exceeded. If this is the case, in step S206 the system determines whether a “pedal rate” is within predefined limiting values. This serves to avoid releases occurring incorrectly due to sudden changes in the position of the accelerator pedal (i.e., checking of the signal plausibility). If the result of the check in step S206 is positive the hydraulic brakes are released in step S207, accordingly, starting of the vehicle is made possible.

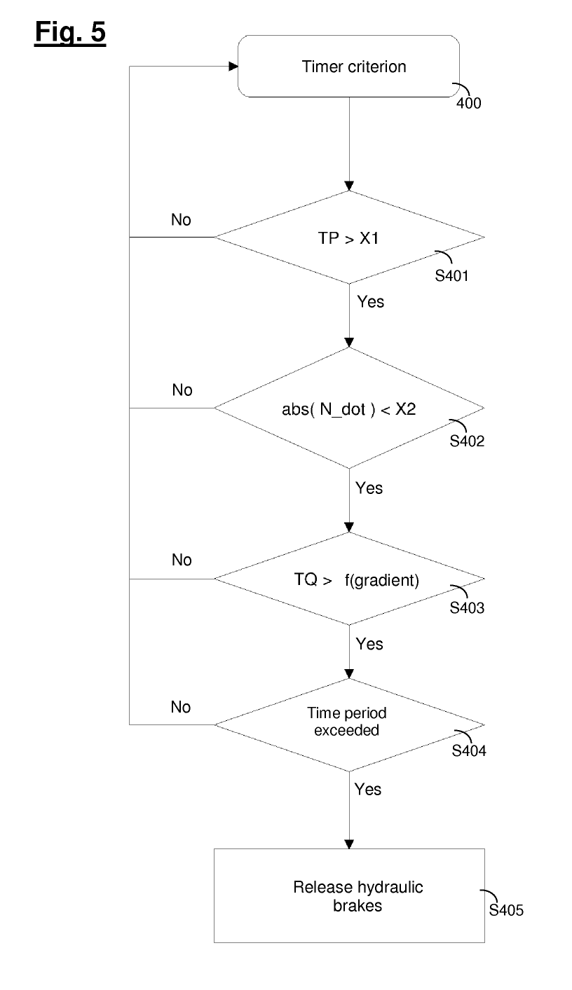

In the case of the “timer” criterion system check 400, according to FIG. 5, the system first checks in step S401 to determine whether the throttle valve opening exceeds a predefined limiting value (i.e., checking is carried out to determine whether the accelerator pedal is activated). If this is the case, checking is carried out in step S402 to determine whether the engine speed stabilizes (i.e., there is no dynamic state present). If this is the case, in step S403 checking is carried out to determine whether the traction torque is high enough. Given a positive result of the checking of step S403, an inquiry is made in step S404 to determine whether a predefined time period has been exceeded (i.e., the state is also present for a comparatively long time period). If this is the case, in step S405 the hydraulic brakes are released and the vehicle can be started.

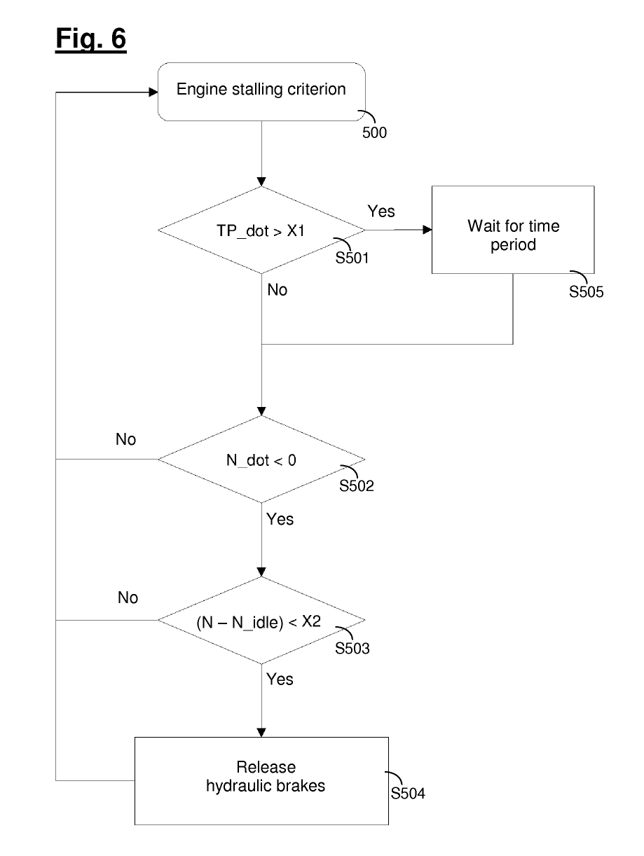

In the case of the “engine stalling” criterion system check 500, according to FIG. 6, an inquiry is firstly made at step S501 to determine whether the change in the throttle valve opening over time exceeds a predetermined limiting value. If this is the case, in step S505 the system waits for the expiration of a predetermined time period in order to avoid activation occurring incorrectly. If the result of the checking in step S501 is negative or if the time period in step S505 expires, an inquiry is made at step S502 to determine whether the derivation of the throttle valve opening over time is negative. This is intended to ensure that the drop in the engine torque is not caused by signal faults or signal peaks. If a positive result of the checking in step S502 occurs checking is carried out in step S503 to determine whether the difference between the engine speed and the idling speed (=N_idle) drops below a predetermined value. If this is the case, in step S504 the hydraulic brakes. The driver is enabled to start the engine.

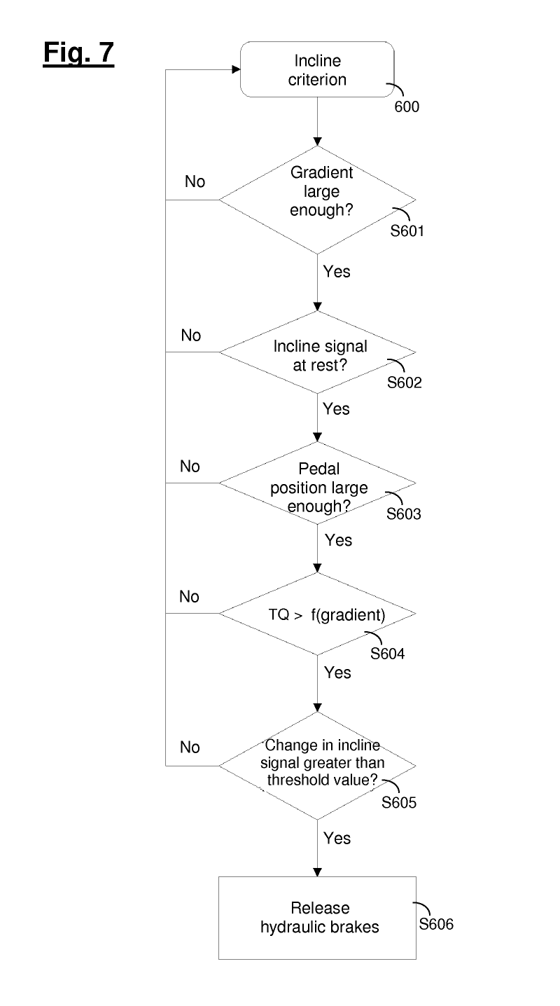

In the “incline” criterion system check 600 according to FIG. 7, a system check is firstly carried out at step S601 to determine whether the incline and/or the gradient are large enough (or greater than a predetermined value) for the criterion to be applied only on comparatively large inclines in the underlying surface. At step S602, checking is then carried out to determine whether the incline signal has come to a rest (i.e., that the vehicle has come to a complete standstill). If this is true, checking is carried out in step S603 to determine whether the throttle valve opening or the activation of the accelerator pedal are sufficiently large (i.e., the driver must activate the accelerator pedal). If this is the case, checking is carried out in step S604 to determine whether the traction torque is sufficiently high or greater than a predetermined value (i.e., sufficiently high to permit starting from the vehicle). If this is the case, in step S605 the incline signal is used to confirm a movement of the vehicle (which is applied by the traction torque applied to the braked wheels). Subsequently, in step S606 the hydraulic brakes are released, accordingly, starting of the vehicle is made possible.

It will be apparent to those skilled in the art that various modifications and variations can be made to the methodologies of the present invention without departing from the scope its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims.

1. A method for determining a clutch engagement point in a motor vehicle which can be driven by means of an engine, having the following steps:
determining a plurality of input signals characteristic of an operating state of the engine; and
evaluating the plurality of input signals in a plurality of criteria which are independent of one another in order to determine the clutch engagement point;
wherein at least one of the plurality of criteria is deactivated at least temporarily as a function of the state of the engine.

2. The method as claimed in claim 1, wherein the evaluating the plurality of input signals includes evaluating at least some of the plurality of criteria in parallel.

3. The method as claimed in claim 1, wherein in evaluating the plurality of input signals for at least one of the plurality of criteria-a specific operating window is predefined within which the respective criterion is used for the determination of the clutch engagement point.

4. The method as claimed in claim 1, wherein the plurality of input signals, which are characteristic of the operating state of the engine, comprises one or more of the following signals: engine speed, rate of change of engine speed, throttle valve position, or rate of change of the throttle valve position.

5. The method as claimed in claim 1, wherein evaluating the plurality of input signals for determining the clutch engagement point checking is carried out for at least one of the following states:
(a) states with changes in the moment of inertia which are caused by a clutch engagement;
(b) states in which the engine torque and engine speed are stable;
(c) states with a drop in the engine torque caused by a clutch engagement;
(d) states in which the engine torque remains constant, when the clutch engagement point is approached; and
(e) states of rapid clutch engagement which can lead to the engine stalling.

6. The method as claimed in claim 1, wherein the clutch engagement point is determined without evaluation of an analog clutch position signal.

7. The method as claimed in claim 1, further comprising:
releasing a brake pressure, which is applied in the motor vehicle, by means of a hill start assistance system on the basis of the determined clutch engagement point.

8. (canceled)

9. A method for determining the clutch engagement point in a motor vehicle, comprising:
performing a criterion system check related to clutch engagement inertia, static torque, clutch engagement torque, time controls or rapid clutch engagements;
transmitting at least one input signal related to the criterion system check to a control module;
determining a clutch engagement point based on the input signal; and
releasing a brake pressure according to the criterion system check.

10. The method of claim 9, wherein the performing a criterion system check includes deriving the throttle valve position over time.

11. The method of claim 9, wherein the performing a criterion system check includes determining whether an engine speed is approaching a setting value.

12. The method of claim 9, wherein the performing a criterion system check includes determining whether a throttle valve opening exceeds a limiting value.

13. The method of claim 9, wherein the performing a criterion system check includes determining whether a time period has been exceeded.

14. The method of claim 9, wherein the performing a criterion system check includes determining whether a rate of change in the accelerator pedal position is within predefined limiting values.

15. The method of claim 9, wherein the performing a criterion system check includes determining whether an engine speed stabilizes.

16. The method of claim 9, wherein the performing a criterion system check includes determining whether the derivation of a throttle valve opening over time is negative.

17. The method of claim 9, wherein the performing a criterion system check includes determining whether a difference between an engine speed and an idling speed is below a predetermined value.

18. The method of claim 9, wherein the performing a criterion system check includes determining whether an incline of an underlying surface is greater than a predetermined value.

19. The method of claim 18, wherein the performing a criterion system check includes determining whether there is vehicle movement.

20. The method of claim 9, wherein the performing a criterion system check includes determining whether traction torque is greater than a predetermined value.
